(19) United States
(12) Patent Application Publication
(10) Pub. No.: US 2021/0319462 A1
(43) Pub. Date: Oct. 14, 2021

(54) SYSTEM AND METHOD FOR MODEL BASED PRODUCT DEVELOPMENT FORECASTING

(71) Applicant: Honda Motor Co., Ltd., Tokyo (JP)

(72) Inventor: Ravi G. Advani, Torrance, CA (US)

(21) Appl. No.: 16/843,382

(22) Filed: Apr. 8, 2020

(51) Int. Cl. G06Q 30/02; G06Q 10/06; G06K 9/62

(52) U.S. Cl. CPC G06Q 30/0202; G06Q 10/06313; G06K 9/6255; G06K 9/6284; G06K 9/6256

(57) ABSTRACT

Systems and methods for model based product development forecasting are provided. In one embodiment, a computer-implemented method for model based product development forecasting includes receiving a description associated with a proposed feature for a vehicle. The computer-implemented method also includes identifying a domain parameter associated with the proposed feature. The domain parameter indicates that the proposed feature pertains to the automotive domain. The computer-implemented method further includes inputting the description and the domain parameter into a trained model. The computer-implemented yet further includes generating a scope parameter for the proposed feature. The scope parameter indicates an amount of at least one resource to develop the proposed feature.

### BACKGROUND

The business world is constantly evolving. Currently, globally integrated enterprises are emerging to frame strategy, management, and operations in pursuit of a new goal, which includes the integration of production and value delivery worldwide with business services as a language of business communication. Current technology strategies must address the requirements of globally integrated enterprises. These requirements may be based on the manner in which resources are deployed and include, for example, corporate performance management, extension of enterprise resource planning, and services oriented architecture.

### BRIEF DESCRIPTION

According to one aspect, a computer-implemented method for model based product development forecasting is provided. The computer-implemented method includes receiving a description associated with a proposed feature for a vehicle. The computer-implemented method also includes identifying a domain parameter associated with the proposed feature. The domain parameter indicates that the proposed feature pertains to the automotive domain. The computer-implemented method further includes inputting the description and the domain parameter into a trained model. The computer-implemented yet further includes generating a scope parameter for the proposed feature. The scope parameter indicates an amount of at least one resource to develop the proposed feature.

According to another aspect, a system for model based product development forecasting is provided. The system includes a memory storing instructions when executed by a processor cause the processor to perform a method. For example, the processor is configured to receive a description associated with a proposed feature for a vehicle. The processor is also configured to identify a domain parameter associated with the proposed feature. The domain parameter indicates that the proposed feature pertains to the automotive domain. The processor is further configured to input the description and the domain parameter into a trained model. The processor is yet further configured to generate a scope parameter for the proposed feature. The scope parameter indicates an amount of at least one resource to develop the proposed feature.

According to yet another aspect, a non-transitory computer readable storage medium storing instructions that when executed by a computer, which includes a processor to perform a method. The method includes receiving a description associated with a proposed feature for a vehicle. The method also includes identifying a domain parameter associated with the proposed feature. The domain parameter indicates that the proposed feature pertains to the automotive domain. The method further includes inputting the description and the domain parameter into a trained model. The method yet further includes generating a scope parameter for the proposed feature. The scope parameter indicates an amount of at least one resource to develop the proposed feature.

### BRIEF DESCRIPTION OF THE DRAWINGS

FIG. 1 is a schematic view of a system for model based product development forecasting according to an example embodiment.

FIG. 2 is an operating environment for a system for model based product development forecasting according to an example embodiment.

FIG. 3 is a schematic overview of model data including a plurality of data types utilized by a system for model based product development forecasting according to an example embodiment.

FIG. 4 is a process flow diagram for utilizing a trained model to generate product development forecasts according to an example embodiment.

FIG. 5 is a process flow diagram for generating a number of scope parameters for a proposed feature according to an example embodiment.

### DETAILED DESCRIPTION

Currently, the advent of deep learning and/or machine learning is being utilized to provide artificial intelligence that may be utilized in various environments. For instance, deep learning and/or machine learning may be utilized with respect to resource development and the analysis of one or more data inputs to output scope parameters may provide insight to one or more features or functions. Training of a model for deep learning and/or machine learning may include a number of different types of data that are related to the relevant technical field. The different data types may include historical data about previous proposed features, vehicle data about the vehicle, feature data, etc. After training a model, suppose a user proposes a new feature for a vehicle associated with an enterprise. The trained model may be used to generate scope parameters for the proposed new feature. For example, the user may provide information about the proposed feature and indicate the relevant technical field. The trained model outputs scope parameters (e.g., man hours, budget, etc.) that forecast the resource deployment that may be necessary to create and deploy the proposed new feature.

### Definitions

The following includes definitions of selected terms employed herein. The definitions include various examples and/or forms of components that fall within the scope of a term and that may be used for implementation. The examples are not intended to be limiting.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) can reside within a process and/or thread. A computer component can be localized on one computer and/or can be distributed between multiple computers.

“Computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

“Communication interface,” as used herein can include input and/or output devices for receiving input and/or devices for outputting data. The input and/or output can be for controlling different vehicle features, which include various vehicle components, systems, and subsystems. Specifically, the term “input device” includes, but is not limited to: keyboard, microphones, pointing and selection devices, cameras, imaging devices, video cards, displays, push buttons, rotary knobs, and the like. The term “input device” additionally includes graphical input controls that take place within a user interface, which can be displayed by various types of mechanisms such as software and hardware-based controls, interfaces, touch screens, touch pads or plug and play devices. An “output device” includes, but is not limited to, display devices, and other devices for outputting information and functions.

“Computer-readable medium,” as used herein, refers to a non-transitory medium that stores instructions and/or data. A computer-readable medium can take forms, including, but not limited to, non-volatile media, and volatile media. Non-volatile media can include, for example, optical disks, magnetic disks, and so on. Volatile media can include, for example, semiconductor memories, dynamic memory, and so on. Common forms of a computer-readable medium can include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Database,” as used herein, is used to refer to a table. In other examples, “database” can be used to refer to a set of tables. In still other examples, “database” can refer to a set of data stores and methods for accessing and/or manipulating those data stores. A database can be stored, for example, at a disk, data store, and/or a memory.

“Display,” as used herein can include, but is not limited to, LED display panels, LCD display panels, CRT display, plasma display panels, touch screen displays, among others, that are often found in vehicles to display information about the vehicle. The display can receive input (e.g., touch input, keyboard input, input from various other input devices, etc.) from a user. The display can be accessible through various devices, for example, though a remote system.

A “disk”, as used herein may be, for example, a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD ROM). The disk may store an operating system that controls or allocates resources of a computing device.

A “memory”, as used herein may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory may store an operating system that controls or allocates resources of a computing device.

A “module”, as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

An “operable connection”, or a connection by which entities are “operably connected”, is one in which signals, physical communications, and/or logical communications may be sent and/or received. An operable connection may include a wireless interface, a physical interface, a data interface and/or an electrical interface.

A “processor”, as used herein, processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

A “value” and “level”, as used herein may include, but is not limited to, a numerical or other kind of value or level such as a percentage, a non-numerical value, a discrete state, a discrete value, a continuous value, among others. The term “value of X” or “level of X” as used throughout this detailed description and in the claims refers to any numerical or other kind of value for distinguishing between two or more states of X. For example, in some cases, the value or level of X may be given as a percentage between 0% and 100%. In other cases, the value or level of X could be a value in the range between 1 and 10. In still other cases, the value or level of X may not be a numerical value, but could be associated with a given discrete state, such as “not X”, “slightly x”, “x”, “very x” and “extremely x”.

A “vehicle”, as used herein, refers to any moving vehicle that is capable of carrying one or more human occupants and is powered by any form of energy. The term “vehicle” includes, but is not limited to: cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” may refer to an electric vehicle (EV) that is capable of carrying one or more human occupants and is powered entirely or partially by one or more electric motors powered by an electric battery. The EV may include battery electric vehicles (BEV) and plug-in hybrid electric vehicles (PHEV). The term “vehicle” may also refer to an autonomous vehicle and/or self-driving vehicle powered by any form of energy. The autonomous vehicle may or may not carry one or more human occupants. Further, the term “vehicle” may include vehicles that are automated or non-automated with pre-determined paths or free-moving vehicles.

“Vehicle control system” and/or “vehicle system,” as used herein can include, but is not limited to, any automatic or manual systems that can be used to enhance the vehicle, driving, and/or safety. Exemplary vehicle systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, an interior or exterior camera system among others. The system may further include a vehicle monitoring system or vehicle modeling system that monitors aspects of the vehicle's operation.

“Vehicle sensor,” as used herein can include various types of sensors for use with a vehicle and/or the vehicle systems for detecting and/or sensing a parameter of the vehicle, the vehicle systems, and/or the environment surrounding the vehicle. For example, the vehicle sensors can provide data about vehicles and/or downstream objects in proximity to the vehicle. For example, the vehicle sensors can include, but are not limited to: acceleration sensors, speed sensors, braking sensors, proximity sensors, vision sensors, ranging sensors, seat sensors, seat-belt sensors, door sensors, environmental sensors, yaw rate sensors, steering sensors, GPS sensors, among others. It is also understood that the vehicle sensors can be any type of sensor, for example, acoustic, electric, environmental, optical, imaging, light, pressure, force, thermal, temperature, proximity, among others.

### I. System Overview

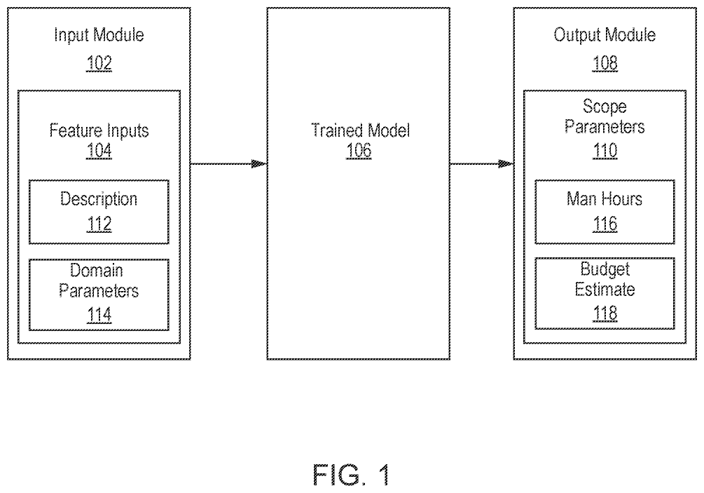

Referring to the drawings, the showings are for purposes of illustrating one or more exemplary embodiments and not for purposes of limiting the same, FIG. 1 is a schematic view of an exemplary system for forecasting product development tangibles. The proposed feature may be a product, good, service, innovation, protocol, or idea, among others that that the user wishes to develop on behalf of an enterprise. The enterprise is an entity, such as a business, commercial entity, inventor, or user. For example, the user may be an agent, employee, or engineer of the enterprise. In another embodiment, the user may be the enterprise, for example, a solo inventor. The user may propose a feature on behalf of the enterprise. For example, suppose that the user is an engineer and the enterprise is an automotive manufacturer. The proposed feature may be a new feature for a vehicle.

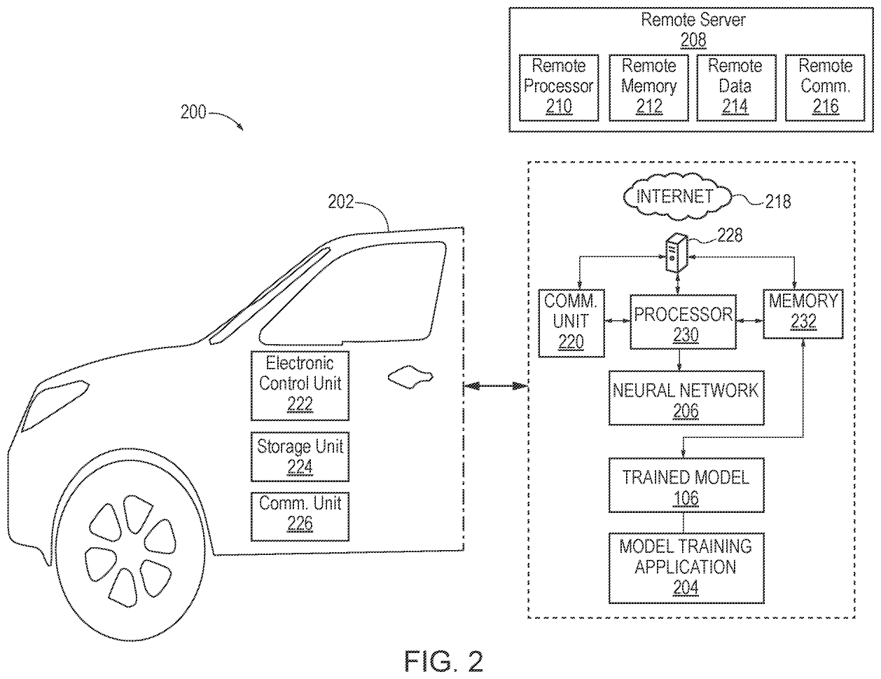

To propose a feature, an input module 102 receives a number of feature inputs 104. The feature inputs 104 are characteristics of the proposed feature. For example, suppose that a weather alert is being proposed for a vehicle 202, shown in FIG. 2. The feature inputs 104 may include a description 112. The description 112 describes the idea and aspects of the proposed feature. For example, the description 112 may include natural/plain language terms that convey aspects of the proposed feature. Accordingly, the proposed feature may include a description 112 of “weather alert,” “alert for vehicle,” “weather notification,” “weather type,” “weather alert for vehicles” etc. The description 112 may also include an abstract, an article, white papers, slideshow, or other documentation associated with the proposed feature.

The feature inputs 104 may also include domain parameters 114. The domain parameters 114 define aspects of the technical field relevant to the proposed feature. The domain parameters 114 may be input by the user or identified from another source. For example, the domain parameters 114 may be identified from the description 112. Suppose the description 112 is provided in plain language. The input module 102 may identify domain parameters 114 based on the plain language of the description 112. For example, the domain parameters 114 may include keywords, predetermined phrases, figures from the description 112.

The domain parameters 114 may include a key system of the vehicle 202 that would be used to affect the weather alert such as infotainment system, a climate system, etc. As another example, the domain parameters 114 may also include a data type (e.g., weather data). The domain parameters 114 may be selectable as an input from categories of domain parameters. In another embodiment, the domain parameters 114 may include components that the proposed feature would interact with. Continuing the example from above in which the proposed feature is a weather alert for the vehicle 202, the components may include a vehicular temperature sensor, infotainment display of the vehicle 202, alert system of the vehicle 202, etc. Thus, the domain parameters 114 may indicate that the proposed feature pertains to the automotive domain meaning that the proposed feature is related to or for the vehicle 202. While the example is described with respect to the automotive domain, the technical field may be related to other technical fields such as robotics, commercial cooking, medical devices, etc.

The feature inputs 104 are applied to a trained model 106 to forecast product development tangibles. In particular, the trained model 106 outputs, to the output module 108, one or more identified scope parameters 110. The scope parameters 110 are predictive of the resources that will be needed to bring the proposed feature to market. For example, the scope parameters may include a man hour prediction 116 and/or a budget estimate 118, among others. The man hour prediction 116 is the estimated amount of human resources that are predicted to be needed to bring the proposed feature to market. The man hour prediction 116 may be given as an estimate as to the number of hours needed to bring the proposed feature to market, an may include but are not limited to an estimate of the number of people needed, an estimate of the number of people needed at different levels within the enterprise, and/or an estimate of the payroll cost associated with the estimated number of man hours, among others. The budget estimate 118 may include a total budget, production expenses, promotion expenses, a budget labor and contractors, and/or budget padding, among others. The scope parameters 110 may be given in language, a value such a range, charts, graphs, etc.

The components of the system of FIG. 1, as well as the components of other systems, hardware architectures, and software architectures discussed herein, may be combined, omitted, or organized into different architectures for various embodiments. For example, the trained model 106 may be a generative adversarial network training model application. Turning to FIG. 2, generally, the trained model 106 is trained using a model training application 204 that may supervise the trained model 106 to train one or more deep neural networks 206 to identify a number of scope parameters 110 associated with a feature for a vehicle 202. For purposes of simplicity, this disclosure will describe the embodiments of the system of FIG. 1 with respect to training one or more deep neural networks 206 to identify scope parameters 110 associated with the vehicle 202. However, it is appreciated that the system 200 may be utilized to train the neural networks 206 to identify one or more scope parameters 110 associated with other aspects of product development and/or resource management.

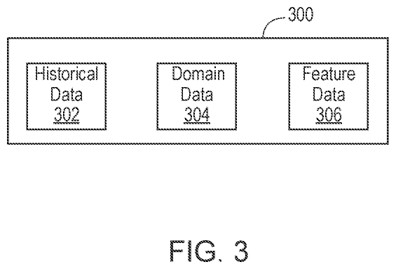

The model training application 204 may be trained using model data 300 such as historical data 302, domain data 304, and feature data 306, as shown in FIG. 3. The historical data 302 includes previous information associated with product development and/or resource management. The historical data 302 may include typical protocols for feature development, project size, project timelines, how long projects typically take within the enterprise, etc. For example, a predetermined number of people may be typically assigned to a feature development team.

The historical data 302 may be maintained by the enterprise or a third party on a remote server 208. The historical data 302 may be received or accessed via the remote server 208. The remote server 208 can include a remote processor 210, a remote memory 212, remote data 214, and a remote communication interface 216 that are configured to be in communication with one another. The remote server 208 may communicate with the vehicle 202 and/or the model training application 204 via the internet cloud 218. In this manner the remote server 208 can be used by the vehicle 202 and/or the model training application 204 to receive and transmit information to and from the remote server 208 and other servers, processors, and information providers. For example, the model training application 204 may be a radio frequency (RF) transceiver used to receive and transmit information to and from the remote server 208. In one embodiment, the remote server 208 may be maintained by a third party, such as a vehicle manufacturer for storing the previous information as remote data 214 in the remote memory 212. The historical data 302 may be generated by the remote processor 210 based on the remote data 214. Accordingly, the historical data 302 may be received at the communication unit 220 from the remote server 208. In another embodiment, the historical data may be received from another source, such as the enterprise.

In a similar manner, the model training application 204 may be configured to communicate with components of the vehicle 202 to receive the domain data 304. The domain data 304 is related to the technical field associated with the domain parameters 114. Continuing the example from above, suppose that domain parameters 114 pertain the automotive domain. Accordingly, the domain data 304 may be vehicle data from one or more vehicles such as the vehicle 202 or about one or more vehicles, like the vehicle 202.

The vehicle 202 may include an electronic control unit (ECU) 222, a storage unit 224, and a communication unit 226. The ECU 222 may execute one or more applications, operating systems, vehicle system and subsystem executable instructions, among others. In one or more embodiments, the ECU 222 may include a microprocessor, one or more application-specific integrated circuit(s) (ASIC), or other similar devices. The ECU 222 may also include an internal processing memory, an interface circuit, and bus lines for transferring data, sending commands, and communicating with the plurality of components of the vehicle 202.

In some configurations, the ECU 222 may include a respective communication device (not shown) for sending data internally to components of the vehicle 202 and communicating with externally hosted computing systems (e.g., external to the vehicle 202). Generally the ECU 222 may be operably connected to the storage unit 224 and may communicate with the storage unit 224 to execute one or more applications, operating systems, vehicle systems and subsystem user interfaces, and the like that are stored on the storage unit 224.

In one or more embodiments, the ECU 222 may be configured to operably control the plurality of components of the vehicle 202. The ECU 222 may also provide one or more commands to one or more control units (not shown) of the vehicle 202 including, but not limited to, a motor/engine control unit, a braking control unit, a turning control unit, a transmission control unit, and the like to control the vehicle 202 to be autonomously operated.

In one or more embodiments, the storage unit 224 may configured to store data that may be output by one or more components of the vehicle 202, including, but not limited to vehicle sensors of the vehicle 202. In particular, the storage unit 224 may store domain data 304 including sensor data from vehicle sensors and or system data from the vehicle systems. The domain data 304 may also include trip log data including records that pertain to location data and time based data associated with locations of the vehicle 202. In some embodiments, the domain data 304 may include, but not be limited to, vehicle data, vehicle sensor data from the vehicle sensors of the vehicle 202, vehicle system data from the vehicle systems of the vehicle 202, traffic data, road data, curb data, vehicle location and heading data, high-traffic event schedules, weather data, or other transport related data. In some embodiments, the domain data 304 can be linked to multiple vehicles, other entities, traffic infrastructures, and/or devices through a network connection, such as via the internet cloud 218 which may be connected to other entities via wireless network antenna, roadside equipment, and/or other network connections.

In one embodiment, the ECU 222 may also be operably connected to the communication unit 226 of the vehicle 202. The communication unit 226 may be operably connected to one or more transceivers (not shown) of the vehicle 202. The communication unit 226 may be configured to communicate through an internet cloud 218 through one or more wireless communication signals that may include, but may not be limited to Bluetooth® signals, Wi-Fi signals, ZigBee signals, Wi-Max signals, and the like.

In one embodiment, the communication unit 220 may be configured to connect to the internet cloud 218 to send and receive communication signals to and from an external server 228. In one configuration, the external server 228 may host the model training application 204 and the deep neural network(s) 206. The external server 228 may be operably controlled by a processor 230 of the external server 228. The processor 230 may be configured to operably control the components of the external server 228 and process information communicated to the external server 228 by the vehicle 202 and/or the model training application 204. In one or more embodiments, the processor 230 may be configured to execute the model training application 204 based on one or more executable files of the trained model 106 that may be stored on a memory 232 of the external server 228.

The model training application 204 may also receive feature data 306 from, for example, the vehicle 202 and/or the remote server 208 among other entities. The feature data 306 may be based on specific features. In one embodiment, the feature data 306 may include information specific to the proposed feature such as how many people were used to develop the proposed feature, how many managers were used to develop the proposed feature, how much time or money has already been invested in the proposed feature.

The model training application 204 may be configured to determine a plurality of labeling functions that may be associated with the center points to analyze the historical data 302, the domain data 304, and the feature data 306. In an exemplary embodiment, the model training application 204 may be configured to input the plurality of labeling functions to the trained model 106 to tune parameters associated with the labeling functions and to utilize a generative model to set probabilistic labels that may pertain to the likelihood of one more scope parameters 110. The probabilistic labels may categorize the scope parameters 110 based on a threshold. For example, the threshold may sort the man hour prediction 116 and/or the budget estimate 118 based on the scope parameters exceeding a predetermined threshold, such as a budget in excess of $100,000. In this manner, the scope parameters 110 may be categorized based on threshold levels.

### II. The GAN Training Application and Related Methods

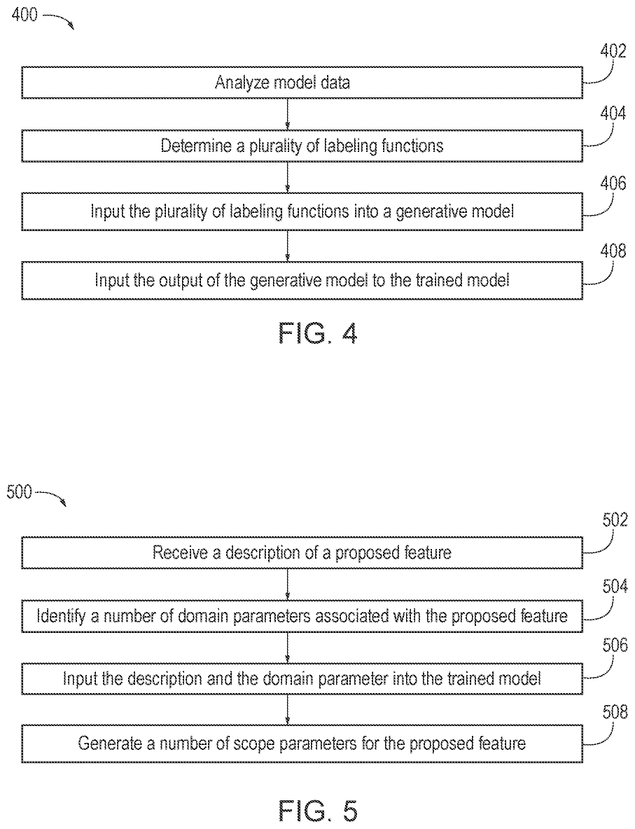

In an exemplary embodiment, the model training application 204 may be stored on the memory 232 and executed by the processor 230 of the external server 228. FIG. 4 is a process flow diagram for utilizing a trained model to generate product development forecasts according to an example embodiment. FIG. 4 will be described with reference to the components of FIG. 1, FIG. 2, and FIG. 3, through it is to be appreciated that the method 400 of FIG. 4 may be used with other systems/components. For simplicity, the method 400 will be described by these steps, but it is understood that the steps of the method 400 can be organized into different architectures, blocks, stages, and/or processes.

At block 402, the method 400 includes analyzing model data. The model data may include the historical data 302, the domain data 304, and/or the feature data 306. Analyzing the model data 300 may include cleaning the model data 300 to remove noisy data and outliers. For example, with respect to historical data 302, suppose that 100s of projects take eighteen months but three projects took seven years. Those three projects may be removed from the historical data at block 402 during cleaning. Accordingly the cleaning may occur based on clustering or normalization of data.

At block 404 the method 400 includes determining a plurality of labeling functions. The Model training application 204 may be further configured to determine a plurality of labeling functions based on the input of analyzed data. The plurality of labeling functions may be associated with various feature inputs 104 and scope parameters 110 that may be determined based on the analysis of the model data 300. The model training application 204 may be configured to examine the plurality of labeling functions that pertain to the identification of respective feature inputs 104 and scope parameters 110. For example, some labeling functions may be based on feature inputs 104 including descriptions 112, domain parameters 114, and scope parameters 110 including a man hour prediction 116 and/or a budget estimate 118. In some embodiments, labeling functions may include, but may not be limited to, durational analysis, description analysis, domain parameter analysis, man hour analysis, budget analysis, and human resource analysis, among others.

At block 406 the method 400 includes imputing the plurality of labeling functions into a generative model. In an exemplary embodiment, the model training application 204 may be configured to input the plurality of labeling functions to a label matrix that may store all of the labeling functions respectively. Accordingly, the label matrix may include results of each of the labeling functions respectively. The label matrix may enable efficient learning of overlaps between various labeling functions. In one embodiment, the labeling functions may be inputted from the label matrix to the trained model. The trained model and may aggregate the plurality of labeling functions to thereby tune parameters associated with the plurality of labeling functions. In particular, the plurality of labeling functions may be inputted to a generative model of the trained model 106 to be aggregated and analyzed to thereby determine probability labels associated with two or more classes. In this manner, a generative model may be used to create classifiers for the trained model 106. In another embodiment, a discriminative model may be used to create classifiers for the trained model 106.

At block 408 the method 400 includes inputting the output of the generative model to the trained model 106. In one configuration, the generative model may output one or more sets of probabilistic labels associated with the classes for training. The discriminative model may be configured to re-weigh a combination of the labeling functions and further train the deep neural network(s) 206 with respect to, for example, a typical number of man hours.

FIG. 5 is a process flow diagram for generating a number of scope parameters for a proposed feature according to an example embodiment. FIG. 5 will be described with reference to the components of FIG. 1, FIG. 2, and FIG. 3, through it is to be appreciated that the method 500 of FIG. 5 may be used with other systems/components. For simplicity, the method 500 will be described by these steps, but it is understood that the steps of the method 500 can be organized into different architectures, blocks, stages, and/or processes.

At block 502 the method 500 include receiving a description 112 of a proposed feature. For example, a user may input a natural/plain language description of the proposed feature, as described above with respect to FIG. 1. The description 112 may be as little as a phrase or as much as a plurality of different types of documents.

At block 504 the method 500 includes identifying a number of domain parameters 114 associated with the proposed feature. The domain parameters 114 are indicative of the technical field of the proposed feature, as described above with respect to FIG. 1. The domain parameters 114 may be based on predetermined classifications. In another embodiment, the input module 102 may generate the domain parameters based on the description 112. For example, the input module 102 may identify key words from the description to determine the domain parameters 114.

In some embodiment, the description 112 and the domain parameters 114 may be input by the user using, for example, a display associated with the an external server 228. The display may receive input (e.g., touch input, keyboard input, input from various other input devices, etc.). In another embodiment, the user may be able to input documents, slides, emails and other communications to the input module 102. In addition to the display, the description 112 and the domain parameters 114 may also be received at the input module 102 may received from the vehicle 202, the remote server 208, or other source.

At block 506 the method 500 includes inputting the description 112 and the domain parameters 114 into the trained model 106. Accordingly, once the user inputs the feature inputs 104, the input module 102 provides the feature inputs 104 to the trained model 106. For example, the input module 102 may provide the description 112 and the domain parameters 114 to the trained model 106 via the communication unit 220, the processor 230 and/or the memory 232 by using the internet cloud 218 or other communication interface such as the communication unit 226 or the communication unit 226.

At block 508 the method 500 includes generating a number of scope parameters 110 for the proposed feature. In some embodiments, the trained model 106 may output the scope parameters 110 via the output module 108. The output module 108 may output a single scope parameter of the scope parameters 110 or a plurality of scope parameters of the scope parameters 110. For example, suppose the trained model 106 includes a first trained model and a second trained model. The first trained model may be designed to yield a single scope parameter, such as a man hour prediction 116. The first trained model may be designed to yield a different scope parameter, such as the budget estimate 118.

In this manner, a plurality of trained modules may be trained using model training application 204 and the model data to identify different scope parameters 110 that forecast the resource development necessary to bring the proposed feature to fruition. For example, if the proposed feature is a feature for the vehicle 202, the model training application 204 may use vehicle data as the domain data 304 to identify how features for vehicles are developed. In addition to the vehicle data, the model data may include historical data 302 about product development for the enterprise and feature data 306 about similar features. Thus, the trained model 106 can be honed by the model training application 204 for specific features in specific technical fields based on the enterprises own behavior.

When a user inputs the description 112 and the domain parameters 114 into the trained model 106. For example, if the description indicates a feature for the vehicle 202, the trained model 106 may output a scope parameter associated with a vehicle 202 in the automotive domain for the enterprise. The scope parameters 110 forecast one or more resources that the enterprise associated with the user may need to deploy to bring the proposed feature to market. Thus, based on the scope parameters 110 the user can identify an amount of at least one resource to develop the proposed feature. Accordingly, the systems and methods herein describe model based product development forecasting.

It should be apparent from the foregoing description that various exemplary embodiments of the disclosure may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium excludes transitory signals but may include both volatile and non-volatile memories, including but not limited to read-only memory (ROM), random-access memory (RAM), magnetic disk storage media, optical storage media, flash-memory devices, and similar storage media.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that several of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computer-implemented method for model based product development forecasting, comprising:
receiving a description associated with a proposed feature for a vehicle;
identifying a domain parameter associated with the proposed feature, wherein the domain parameter indicates that the proposed feature pertains to an automotive domain;
inputting the description and the domain parameter into a trained model; and
generating a scope parameter for the proposed feature, wherein the scope parameter indicates an amount of at least one resource to develop the proposed feature.

2. The computer-implemented method for the model based product development forecasting of claim 1, wherein the domain parameter are identified based on keywords from the description.

3. The computer-implemented method for the model based product development forecasting of claim 1, wherein the description includes plain language terms that convey aspects of the proposed feature

4. The computer-implemented method for the model based product development forecasting of claim 1, wherein the trained model is trained based on model data including historical data, domain data, and feature data.

5. The computer-implemented method for the model based product development forecasting of claim 4, wherein the domain data is vehicle data from the vehicle.

6. The computer-implemented method for the model based product development forecasting of claim 4, wherein the model data is analyzed to remove noisy data and outliers

7. The computer-implemented method for the model based product development forecasting of claim 6, wherein a plurality of labeling functions are determined based on the analyzed model data, and wherein the plurality of labeling functions are input into a generative model used to train the trained model.

8. A system for model based product development forecasting, the system comprising:
a memory storing instructions when executed by a processor cause the processor to:
receive a description associated with a proposed feature for a vehicle;
identify a domain parameter associated with the proposed feature, wherein the domain parameter indicates that the proposed feature pertains to an automotive domain;
input the description and the domain parameter into a trained model; and
generate a scope parameter for the proposed feature, wherein the scope parameter indicates an amount of at least one resource to develop the proposed feature.

9. The system for model based product development forecasting of claim 8, wherein the domain parameter are identified based on keywords from the description.

10. The system for model based product development forecasting of claim 8, wherein the description includes plain language terms that convey aspects of the proposed feature.

11. The system for model based product development forecasting of claim 8, wherein the trained model is trained based on model data including historical data, domain data, and feature data.

12. The system for model based product development forecasting of claim 11, wherein the domain data is vehicle data from the vehicle.

13. The system for model based product development forecasting of claim 11, wherein the model data is analyzed to remove noisy data and outliers, wherein a plurality of labeling functions are determined based on the analyzed model data, and wherein the plurality of labeling functions are input into a generative model used to train the trained model.

14. A non-transitory computer readable storage medium storing instructions that when executed by a computer, which includes a processor perform a method, the method comprising:
receiving a description associated with a proposed feature for a vehicle;
identifying a domain parameter associated with the proposed feature, wherein the domain parameter indicates that the proposed feature pertains to an automotive domain;
inputting the description and the domain parameter into a trained model; and
generating a scope parameter for the proposed feature, wherein the scope parameter indicates an amount of at least one resource to develop the proposed feature.

15. The non-transitory computer readable storage medium of claim 14, wherein the domain parameter are identified based on keywords from the description.

16. The non-transitory computer readable storage medium of claim 14, wherein the description includes plain language terms that convey aspects of the proposed feature.

17. The non-transitory computer readable storage medium of claim 14, wherein the trained model is trained based on model data including historical data, domain data, and feature data.

18. The non-transitory computer readable storage medium of claim 17, wherein the domain data is vehicle data from the vehicle.

19. The non-transitory computer readable storage medium of claim 17, wherein the model data is analyzed to remove noisy data and outliers

20. The non-transitory computer readable storage medium of claim 19, wherein a plurality of labeling functions are determined based on the analyzed model data, and wherein the plurality of labeling functions are input into a generative model used to train the trained model.
